(19) United States
(12) Patent Application Publication
(10) Pub. No.: US 2018/0051903 A1
(43) Pub. Date: Feb. 22, 2018

(54) APPARATUS FOR INHIBITING AIRFLOW THROUGH A CONDUIT

(71) Applicant: Thermal Technics (1982) Corp., Bolton (CA)

(72) Inventor: Anthony Carroll Monk, Bolton (CA)

(73) Assignee: Thermal Technics (1982) Corp., Bolton (CA)

(21) Appl. No.: 15/240,540

(22) Filed: Aug. 18, 2016

(51) Int. Cl. F24F 13/14; F24F 12/00; F16K 15/03; F16K 1/20

(52) U.S. Cl. CPC F24F 13/1406; F16K 1/2007; F16K 15/031; F24F 12/006

(57) ABSTRACT

An apparatus includes a frame and a damper blade moveable between a closed position and an open position. A biasing member is coupled to the frame and exerts a biasing force to urge the damper blade towards a substantially closed position. A magnet coupled to the damper blade exerts a magnetic force to pull the damper blade from the substantially closed position to the closed position. When the damper blade is in the open position and an upstream airflow pressure falls below a first predetermined threshold, the biasing member moves the damper blade to the substantially closed position, and the magnetic force then pulls the damper blade to the closed position, automatically inhibiting airflow through the frame. When the damper blade is in the closed position and an upstream airflow pressure is increased to a second predetermined threshold, the damper blade is released from the closed position.

### FIELD

This disclosure relates generally to apparatus for inhibiting airflow through a conduit, and more specifically to apparatus for inhibiting airflow through a supply duct when a supply fan upstream of the apparatus is turned off or otherwise disabled.

### BACKGROUND

Ventilation or airflow systems are used to convey air into, out of, and/or within residential, commercial, and/or industrial buildings. For example, most residential buildings have a ventilation system for drawing in, circulating, and exhausting air at one or more locations within the building. In multi-unit residential dwellings, each unit may have its own independent dedicated fresh air intake and air exhaust system. Such an intake air system is usually connected to a hydronic air conditioning appliance.

Typically, ventilation systems include at least one flow control mechanism, for example an airflow damper for inhibiting outside air from freely entering the building and/or the ventilation system. Such entry of air could be particularly undesirable in colder climates if the incoming air is not tempered, and may occur if the ventilation system is not forcefully drawing in or exhausting air, for example, while a supply fan is turned off, cycling at a low airflow setting, or malfunctioning.

Once a ventilation system has been installed and covered by interior wall and/or ceiling finishes, accessing the ventilation system for service or repair can be time consuming and expensive.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

A ventilation system for a residential building and/or an individual residential unit within a multi-unit building may include one or more devices or apparatus for treating or conditioning the air to provide an environment with desired air characteristics, such as temperature, humidity, cleanliness, etc. For example, a heat recovery ventilation system for tempering air in colder climates may include a cross-flow or counter-flow heat exchanger between a fresh air intake and an exhaust air outlet.

Residential ventilation systems may include a motorized supply fan to induce an airflow of fresh air into an air conditioning unit for the building or unit in which the ventilation system is installed. In heat recovery ventilation systems, such a supply fan (alternatively referred to as a supply blower) is often located downstream of a heat exchanger.

It is often desirable to inhibit fresh air from freely entering the building and/or the ventilation system. For example, particularly in colder climates, it may be desirable to selectively inhibit very cold air from entering the building or unit. If cold air is allowed to flow unimpeded through an air intake or outlet conduit, this may lead to uncomfortably low temperatures in the building or unit. Alternatively, or additionally, devices or appliances within the ventilation system may be damaged by undesired and/or prolonged exposure to cold air. For example, a hydronic coil of an air conditioning unit may freeze as a result of undesired exposure to very cold airflow.

In some residential ventilation systems, a motorized damper (e.g. a motorized spring return control damper) may be provided to selectively inhibit outside air from flowing into the building or unit. For example, a motorized damper may be configured to close in response to low temperature air being detected (e.g. as determined by an air temperature sensor). Alternatively, or additionally, a motorized damper may be configured to close when a supply fan or blower is not operating in order to control the rate of airflow into the building or unit. Alternatively, or additionally, a motorized damper may be configured to close if a failure of the supply fan is detected. Typically, such a motorized control damper will be located adjacent the air intake conduit, and in heat recovery ventilation systems, upstream of the heat exchanger.

Using a motorized control damper to inhibit outside air from freely entering the building and/or the ventilation system may have one or more disadvantages. For example, such a damper may require separate and/or additional control electronics, which may increase the cost, complexity, and/or failure rate of the control damper. For example, a separate temperature sensor to detect very cold air may be required. Also, if the motorized control damper is a normally closed damper (i.e. supplying power to the motor opens/holds open the damper, while removing power from the motor results in the damper closing), this may require additional power to be supplied to the ventilation system, lowering its overall efficiency and/or its reliability.

Also, if the supply fan or blower is periodically cycled into a low or off condition, and the motorized control damper is not closed during periods in which the fan is cycled to low or off, there may still be a relatively uninhibited flow path for exterior air to enter the building or unit, particularly where there is a significant pressure difference between the exterior or fresh air and the air within the building or unit. For example, if the outside air is colder than the inside air, there will be a tendency for the cooler (relatively higher pressure) air to flow into the warmer (relatively lower pressure) building or unit—such a pressure-induced airflow will be greater if the fresh exterior air is colder, potentially exacerbating an undesirable situation.

As disclosed herein, an apparatus for inhibiting airflow through a conduit has a frame and a damper blade. The damper blade is moveable between a closed position and an open position, and mechanically biased towards a substantially closed position. A magnet secured to the damper blade is configured to pull the damper blade from the substantially closed position to the closed position, and to releasably retain the damper blade in the closed position. The apparatus is configured so that when a supply fan positioned upstream of the apparatus is not operating (or otherwise fails to supply a predetermined airflow pressure against the damper blade), the damper blade moves to and is maintained in the closed position. The apparatus is also configured so that while a supply fan positioned upstream of the apparatus is turned on (or otherwise increases the airflow pressure it provides above another predetermined threshold) while the damper blade is in the closed position, the magnetic retention is overcome and the damper blade moves to and is maintained in the open position.

Preferably, the frame is made of a ferromagnetic material, and the damper blade is made of a paramagnetic material. It has been determined that using a ferromagnetic frame and a paramagnetic damper blade facilitates the provision of a lower magnetic ‘break force’ required to release the damper blade from the closed position. This facilitates the configuration of the apparatus so that the damper blade closes (and remains closed) when the supply fan is not operating, while allowing the damper blade to be reliably opened using airflow pressure generated by the supply fan.

The apparatus and methods disclosed herein may have one or more advantages over the use of a motorized spring return control damper. For example, the apparatus does not require a power source or control electronics, instead opening and closing in response to airflow pressures within the ventilation system, such as airflow pressures generated by an upstream supply fan. Also, the apparatus may be factory calibrated based on its expected operating environment, such as the size and power output of an adjacent supply fan. Also, the apparatus may require little or no servicing or maintenance once installed. Also, the apparatus may offer improved reliability over a motorized control damper. Also, the apparatus may be more economical to manufacture, install, and/or maintain.

In accordance with a broad aspect, there is provided an apparatus for inhibiting airflow through a conduit, the apparatus comprising: a frame configured for mounting in fixed relation to the conduit in a position a first distance downstream of an airflow fan, the frame having an upstream face and a downstream face, the frame defining a central aperture from the upstream face to the downstream face; a damper blade pivotally secured to the frame and moveable between a closed position in which a perimeter of the damper blade abuts the downstream face of the frame and airflow through the aperture is inhibited and an open position in which the damper blade is spaced apart from the downstream face of the frame and airflow through the aperture is permitted; a biasing member coupled to the frame and configured to be in contact with a downstream face of the damper blade when the damper blade is in the open position to exert a biasing force against the damper blade to urge the damper blade towards a substantially closed position, wherein the biasing member is positioned downstream of the downstream face of the frame; and a magnet coupled to the damper blade and configured to exert a magnetic force between the frame and the magnet to pull the damper blade from the substantially closed position to the closed position; wherein when the damper blade is in the open position and an airflow pressure provided by the airflow fan falls below a first predetermined threshold, the biasing force exerted by the biasing member moves the damper blade to the substantially closed position, and the magnetic force then pulls the damper blade to the closed position and releasably retains the damper blade in the closed position, thereby inhibiting airflow through the conduit, and wherein when the damper blade is in the closed position and an airflow pressure provided by the airflow fan is increased to a second predetermined threshold, the magnetic force is overcome and the damper blade moves towards the open position.

In some embodiments, the damper blade is made from a paramagnetic material and the frame is made from a ferromagnetic material.

In some embodiments, the damper blade is made from at least one of aluminum, tin, and titanium.

In some embodiments, the frame is made from at least one of galvanized steel and stainless steel.

In some embodiments, the frame further comprises a flange extending outwardly from the downstream face of the frame, and the biasing member comprises a resiliently flexible member having a first end and a second end, the first end being secured to the flange, and the second end configured to abut the downstream face of the damper blade when the damper blade is in the open position.

In some embodiments, the first end of the resiliently flexible member has a width that is greater than a width of the second end of the resiliently flexible member.

In some embodiments, the resiliently flexible member is made from at least one of stainless steel, spring steel, and rubber.

In some embodiments, the magnet has a strength of at least 32 Gauss.

In some embodiments, the magnet has a strength of between 32 and 105 Gauss.

In some embodiments, the perimeter of the damper blade is generally rectangular.

In some embodiments, the perimeter of the damper blade is generally circular.

In some embodiments, the first predetermined threshold is about 0.085 kPa, and the second predetermined threshold is about 0.09 kPa.

In some embodiments, the conduit is a supply air inlet of a thermal recovery unit.

In some embodiments, the first distance is less than 76 mm.

In accordance with another broad aspect, there is provided a thermal recovery unit for installation in a residential dwelling, the thermal recovery unit comprising: a housing having an interior air inlet, an exterior air inlet, an interior air outlet, and an exterior air outlet; a first conduit extending between the interior air inlet and the exterior exhaust outlet; a second conduit extending between the exterior air inlet and the interior air outlet; a supply fan positioned adjacent to the interior air outlet; and a damper assembly positioned downstream of the supply fan by a first distance, the damper assembly comprising: a frame having an upstream face and a downstream face; a damper blade pivotally secured to the frame and moveable between a closed position in which airflow through the second conduit is inhibited and an open position in which airflow through the second conduit is permitted; a biasing member coupled to the frame and configured to be in contact with a downstream face of the damper blade when the damper blade is in the open position to exert a biasing force against the damper blade to urge the damper blade towards a substantially closed position; and a magnet coupled to the damper blade and configured to exert a magnetic force between the frame and the magnet to pull the damper blade from the substantially closed position to the closed position; wherein when the damper blade is in the closed position, the supply fan is operable to provide an airflow pressure sufficient to overcome the magnetic force and move the damper blade to the open position, and wherein when the damper blade is in the open position and the supply fan is turned off, the biasing force exerted by the biasing member moves the damper blade to the substantially closed position, and the magnetic force then pulls the damper blade to the closed position, thereby automatically closing the damper assembly.

In some embodiments, the first distance is less than 76 mm.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of an apparatus for inhibiting airflow through a conduit according to one embodiment, with the damper blade in an open position;

FIG. 2 is a perspective view of the apparatus of FIG. 1, with the damper blade in the closed position;

FIG. 3 is a perspective view of an apparatus for inhibiting airflow through a conduit according to another embodiment, with the damper blade in an open position;

FIG. 4 is another perspective view of the apparatus of FIG. 3;

FIG. 5 is a perspective view of a thermal recovery unit for use in a multi-unit residential building;

FIG. 6 is a top view of the thermal recovery unit of FIG. 5;

FIG. 7 is a schematic view of the airflow through the thermal recovery unit of FIG. 5.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

While the apparatus and methods disclosed herein are described specifically in relation to the use of the apparatus to inhibit ducted supply air from entering a building or ventilation system due to naturally occurring pressure differentials, for example to inhibit below freezing air from entering a warmer building, or to inhibit air from entering due to wind or stack effects (external and/or internal), etc., it will be appreciated that the same apparatus may alternatively be used in other ventilation systems. For example, the apparatus may be used on systems in which a thermal recovery unit is connected to an air conditioning appliance.

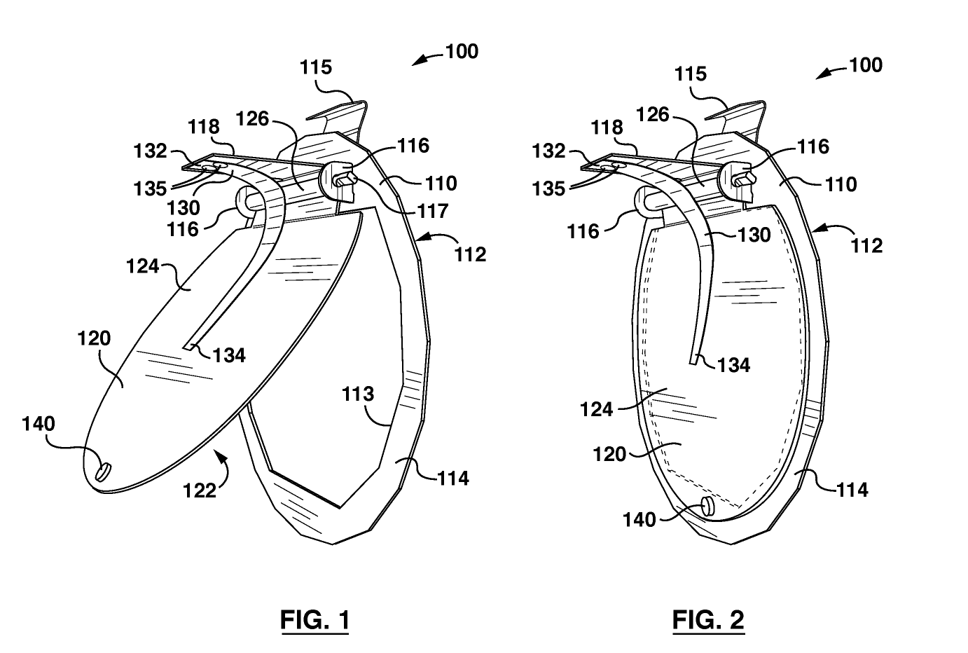

Reference is now made to FIGS. 1 and 2, which illustrate an apparatus 100 for inhibiting airflow through a conduit. Apparatus 100 may also be referred to as a damper assembly 100. Damper assembly 100 includes a frame 110 that has an inner perimeter 113 that defines an opening or aperture in the frame 110 through which air can flow. Damper assembly 100 also has a damper blade or flap 120 that is moveable between an open position in which the opening in frame 110 is relatively unobstructed by the damper flap 120 (e.g. as shown in FIG. 1), and a closed position in which the damper flap inhibits (and preferably prevents) airflow through the opening in frame 110 (e.g. as shown in FIG. 2). Damper assembly 100 also includes a biasing member 130 for urging the damper flap from the open position towards a partially closed position, and a magnet 140 for urging the damper flap from the substantially closed position to the closed position, and for releasably retaining the damper blade in the closed position.

As will be discussed further below, apparatus or damper assembly 100 is preferably configured so that the damper flap 120 remains in an open position as long as an airflow pressure on the upstream face of the damper flap remains above a first predetermined threshold, such as the airflow pressure expected to be developed by a supply fan positioned upstream of the apparatus during normal operation. Apparatus 100 is also preferably configured so that the damper flap 120 may be released from the closed position and be moved to the open position when an upstream airflow pressure is increased to a second predetermined threshold, such an airflow pressure also capable of being supplied by the supply fan or blower positioned upstream of the apparatus.

Accordingly, when installed in (or against the end of) an airflow conduit and downstream of a supply fan, if the supply fan is not operating the damper blade automatically moves to and is maintained in the closed position, thereby inhibiting outside air from freely entering the building and/or the ventilation system. For example, if the supply fan fails, is turned off, or otherwise fails to supply a predetermined airflow pressure against the damper blade, the damper assembly automatically closes. Further, if the upstream supply fan is turned on while the damper blade is in the closed position, the damper blade automatically moves to and is maintained in the open position, thereby allowing outside air to be drawn into the building and/or the ventilation system by the supply fan. Preferably, the apparatus is installed within about 50 to 76 mm of the upstream supply fan wheel.

Frame 110 has a first (or upstream) face 112, a second (or downstream) face 114, and an inner perimeter 113 that defines an opening from the upstream face 112 to the downstream face 114. Frame 110 may be made from any suitable material. As will be discussed further below, frame 110 is preferably made from a ferromagnetic material, such as galvanized steel, stainless steel, and the like.

Frame 110 is preferably dimensioned so that it can be secured within an airflow conduit, or with the downstream face 114 positioned against an end of an airflow conduit, preferably downstream of a powered airflow fan.

Preferably, frame 110 and its opening have the same general shape as the airflow conduit in or against which it is to be mounted. For example, apparatus 100 has a generally circular shape, suitable for use with a generally circular conduit. It will be appreciated that frame 110 may have any suitable shape.

Optionally, one or more mounting features, such as mounting projection 115, may be provided to facilitate the securement of apparatus 100 into the ventilation system. Alternatively, more or fewer (i.e. no) mounting features may be provided.

Damper flap 120 has a first (or upstream) face 122 and a second (or downstream) face 124. Damper flap 120 may be made from any suitable material. As will be discussed further below, damper flap 120 is preferably made from a paramagnetic material, such as aluminum, tin, titanium, and the like.

Damper flap 120 is pivotally coupled to frame 110. In the illustrated embodiment, a pair of projections or flanges 116 extend outwardly from the downstream face 114 of frame 110. Flanges 116 are each configured to retain an end of a pivot member or shaft 117, about which the damper flap 120 pivots. Preferably, shaft 117 is generally parallel to the downstream face 114 of frame 110. In the illustrated embodiment, an upper portion of damper flap 120 is rolled or otherwise formed to create a hollow section or knuckle 126 through which shaft 117 can be inserted or otherwise positioned. When shaft 117 is positioned interior of hollow section or knuckle 126 and the ends of shaft 117 are retained by flanges 116, damper flap 120 is thereby pivotally coupled to frame 110. It will be appreciated that any suitable pivotal coupling method may alternatively be used.

In FIG. 1, damper blade 120 is shown in an open position. In this position, the opening in frame 110 is relatively unobstructed by the damper flap 120, and airflow though the frame 110 is relatively unimpeded.

In FIG. 2, damper blade 120 is shown in a closed position. In this position, the upstream face 122 of damper flap 120 is in contact with the downstream face 114 of frame 110 around all (or substantially all) of the inner perimeter 113, thereby inhibiting airflow through the opening in frame 110. Preferably, the abutting portions of damper flap 120 and frame 110 are each generally planar. Alternatively, the abutting portions may have complementary, non-planar surfaces. Optionally, one or more seal or gasket members (not shown) may be provided on the downstream face 114 of frame 110 about some or all of perimeter 113 and/or on the upstream face 122 of damper blade 120 to further inhibit airflow through the frame 110 when the damper blade 120 is in the closed positon.

Damper assembly 100 also includes a biasing member for urging the damper blade 120 from the open position towards a substantially closed position. In the example illustrated in FIGS. 1 and 2, the biasing member comprises a resilient elongate member 130. A first end 132 of member 130 is secured to a projection or flange 118 that extends outwardly from upstream face 112. In the illustrated embodiment, end 132 is secured to projection 118 using a pair of rivets 135. The first end 132 may be secured to the frame 110 using any suitable coupling method (e.g. using a screw and a threaded insert, using a set screw or other mechanical fastener, etc.). Optionally, a suitable adhesive may be used to secure first end 132 to frame 110.

A second end 134 of resilient member 130 is configured to contact the downstream face 124 of damper blade 120 when the damper blade is in an open position (e.g. as shown in FIG. 1), and to exert a biasing force against the damper blade towards a substantially closed position intermediate the open position and the closed position. Optionally, the second end 134 may be configured to remain in contact with the downstream face 124 of damper blade 120 when the damper blade is in the closed position.

In the illustrated embodiment, the first end 132 of resilient member 130 is wider than the second end 134, and resilient member 130 has a generally linear or continuous taper from the first end 132 to the second end 134. It will be appreciated that resilient member 130 may alternatively have a curved taper, a parabolic taper, a series of tapers, no taper, or any other suitable profile. In some embodiments, the first end 132 of resilient member 130 may be narrower than the second end 134.

Resilient member 130 may be made from any suitable material, such as stainless steel, spring steel, rubber, and the like.

When the damper blade 120 is in the open position, the biasing member is configured to exert a biasing force against the damper blade 120 to urge the damper blade towards the partially closed position. In the illustrated embodiment, when the damper blade 120 is in the open position, the second end 134 of resilient member 130 exerts a force against the downstream face 124 of damper blade 120 to urge the damper blade towards the frame 110.

Apparatus 100 is preferably configured so that the force exerted by the biasing member is less than the expected force exerted on the upstream face 122 of the damper blade 120 by the airflow pressure expected to be supplied by a supply fan or blower positioned upstream of the apparatus 100 in an airflow system.

For example, if the apparatus is positioned 76 mm downstream of a centrifugal supply fan expected to develop a downstream airflow pressure of 0.09 kPa during normal (e.g. steady-state) operation, the apparatus 100 may be configured so that the damper flap 120 remains in the open position as long as an airflow pressure of 0.085 kPa is applied to the upstream face 122 of damper flap 120.

Also, while in the open position, apparatus 100 preferably introduces a relatively small static pressure increase in the ventilation system in to which it is installed. For example, if the frame 110 has an opening of about 39 cm², for an airflow velocity of 1.54 m/s, the static pressure increase introduced by the damper in the open position is preferably below 0.017 kPa.

It will be appreciated that configuration of apparatus 100 so that the damper blade 120 remains in the open position as long as an airflow pressure provided by the airflow fan remains above a predetermined threshold is dependent on a number of parameters. These parameters include, for example: the cross-sectional area of the opening through the frame 110; the cross-sectional area of the damper flap 120; the size and elasticity of resilient member 130, friction in the pivotal coupling between frame 110 and damper blade 120, etc.

For example, testing indicated that for a frame 110 with a 35 cm² opening and a 38 cm² damper blade 120, a 9 cm×1.8 cm×0.004 inch resilient member 130 made of stainless steel, the damper flap remained in the open position as long as a 0.085 kPa sustained airflow pressure was applied to the upstream face of the damper flap following the application of a 0.09 kPa airflow pressure to open the damper flap.

As shown in FIGS. 1 and 2, the entire biasing member or resilient member 130 is preferably positioned downstream of the downstream face 114 of the frame 110. This positioning may result in one or more advantages. For example, this may allow the overall apparatus 100 to have a generally planar upstream face, which may facilitate its installation against an end of an airflow conduit. Also, in this positioning both the pivotal coupling or hinge assembly about which the damper flap pivots and the biasing member are located outside of the expected airstream through the frame 110, which may reduce the static pressure introduced by the apparatus 100 when the damper flap 120 is in the open position.

Also, positioning the entire biasing member 130 downstream of the downstream face 114 of the frame 110 may facilitate the installation of apparatus 100 in close proximity to an upstream supply fan wheel. The relative positioning of the damper blade 120 to the supply fan wheel may impact the ability to develop sufficient velocity pressure to release the damper flap from a closed position. For example, as noted above, apparatus 100 is preferably installed within about 50 to 76 mm of the upstream supply fan wheel.

Damper assembly 100 also includes a magnet 140 coupled to the damper blade for urging or pulling the damper blade 120 from a substantially closed position to the closed position. As illustrated in FIGS. 1 and 2, magnet 140 is preferably positioned on the damper blade 120 in a location on the opposite side of the frame opening from the pivotal coupling between the frame 110 and the damper flap 120. When the damper blade 120 is in the substantially closed position, the attractive magnetic force between magnet 140 and frame 110 is sufficient to pull the damper blade 120 into the closed position. While one magnet 140 is shown in the example embodiment, it will be appreciated that two or more magnets may be provided in alternative embodiments.

Magnet 140 is also configured to releasably retain the damper blade in the closed position. That is, when the damper blade 120 is in the closed position, magnet 140 provides sufficient holding force against frame 110 to retain the damper blade in the closed position until a predetermined threshold airflow pressure is applied to the upstream face 122 of damper flap 120. Preferably, apparatus 100 is configured so that this threshold ‘break’ pressure is capable of being supplied by a supply fan or blower positioned upstream of the apparatus 100 in an airflow system.

For example, if the apparatus is positioned 76 mm downstream of a centrifugal supply fan capable of developing an airflow pressure of 0.09 kPa, the apparatus 100 may be configured so that the damper flap 120 may be released from the closed position and be moved by the airflow pressure to the open position when an airflow pressure of 0.09 kPa is applied to the upstream face 122 of damper flap 120.

It will be appreciated that configuration of apparatus 100 to provide a suitable threshold ‘break’ pressure to release the damper blade 120 from the closed position is dependent on a number of parameters. These parameters include, for example: the cross-sectional area of the opening through the frame 110; the size and strength of magnet 140 (preferably between about 32 and 105 Gauss, although any suitable strength magnet may be used); the size and elasticity of resilient member 130, friction in the pivotal coupling between frame 110 and damper blade 120, etc.

It has also been found that the material of frame 110 and the material of damper blade 120 have a significant influence on the pressure required to ‘break’ or overcome the holding force provided by magnet 140 when the damper blade 120 is in the closed position. In this respect, experimentation and testing suggest that using a ferromagnetic frame and a paramagnetic damper blade facilitates the provision of a lower or ‘soft break’ force required to release the damper blade from the closed position, as compared to, e.g., the use of a ferromagnetic frame and a ferromagnetic damper blade, which tends to provide a higher or ‘hard break’ force, all else being equal. Thus, use of a ferromagnetic frame and a paramagnetic damper blade may facilitates the configuration of the apparatus so that the damper blade closes (and remains closed) when an upstream supply fan is not operating, while allowing the damper blade to be reliably opened using airflow pressure generated by the supply fan when the fan is operating.

For example, testing indicated that for a steel (i.e. ferromagnetic) frame 110 with a 38 cm² opening, an aluminum (i.e. paramagnetic) damper blade 120, and a 32 gauss magnet, the damper flap remained in the closed position until a 0.09 kPa airflow pressure was applied to the upstream face of the damper flap, at which point the magnetic holding force was overcome and the damper blade moved to the open position.

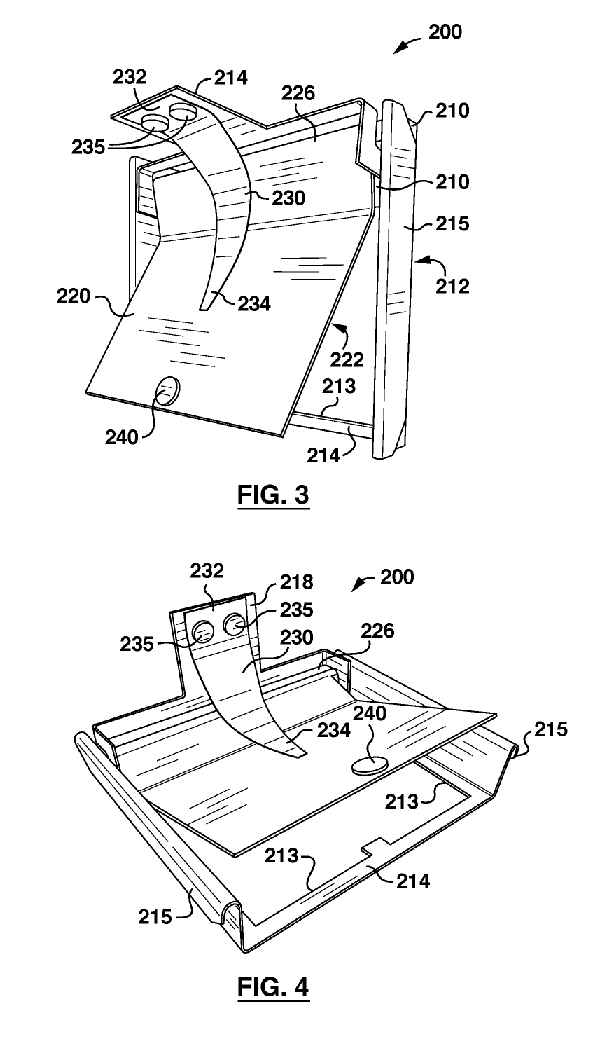

As illustrated in FIGS. 1 and 2, frame 110 is generally circular, and would be suitable for use with a circular airflow conduit. Reference is now made to FIGS. 3 and 4, which illustrate another example embodiment of an apparatus or damper 200 for inhibiting airflow through a conduit. Apparatus 200 has a generally square shape, suitable for use with a generally square conduit. Similar to damper assembly 100, damper assembly 200 includes a frame 210, a damper blade or flap 220 that is moveable between an open position (e.g. as shown in FIGS. 3 and 4) and a closed position (not shown), a biasing member 230, and a magnet 240. In FIGS. 3 and 4, like features as in FIGS. 1 and 2 are referred to with like reference numerals, with the first digit incremented by 1.

As with frame 110 of apparatus 100, frame 210 of apparatus 200 is preferably dimensioned so that it can be secured in (or against an end of) an airflow conduit, preferably downstream of a powered airflow fan. Preferably, frame 210 and its opening have the same general shape as the airflow conduit against which it is to be mounted. As shown in FIGS. 3 and 4, the entire biasing member or resilient member 230 is preferably positioned downstream of the downstream face of the frame 210.

As with apparatus 100, apparatus or damper 200 is preferably configured so that the damper flap 220 remains in an open position as long as an airflow pressure on the upstream face of the damper flap remains above a first predetermined threshold. That is, apparatus 200 is preferably configured so that the force exerted by the biasing member 230 is less than the expected force exerted on the upstream face 222 of the damper blade 220 by the airflow pressure expected to be supplied by a supply fan or blower positioned upstream of the apparatus 200 during normal operation.

It will be appreciated that configuration of apparatus 200 so that the damper blade 220 remains in the open position as long as an airflow pressure provided by the airflow fan remains above a predetermined threshold is dependent on a number of parameters. These parameters include, for example: the cross-sectional area of the opening through the frame 210; the cross-sectional area of the damper flap 220; the size and elasticity of resilient member 230, friction in the pivotal coupling between frame 210 and damper blade 220, etc.

For example, testing indicated that for a frame 210 with a 32.2 cm² opening and a 36.8 cm² damper blade 220, a 7 cm×1.8 cm×0.005 inch resilient member 230 made of stainless steel, the damper flap remained in the open position as long as a 0.085 kPa sustained airflow pressure was applied to the upstream face of the damper flap following the application of a 0.09 kPa airflow pressure to open the damper flap.

Apparatus or damper 200 is also preferably configured so that the damper flap 220 may be released from the closed position and be moved to the open position when an upstream airflow pressure is increased to a second predetermined threshold, such an airflow pressure also capable of being supplied by a supply fan or blower positioned upstream of the apparatus.

As with apparatus 100, apparatus 200 is preferably configured so that the threshold ‘break’ pressure required to overcome the magnetic holding force of magnet 240 is capable of being supplied by the supply fan or blower positioned upstream of the apparatus 200 in an airflow system. The configuration of apparatus 200 to provide a suitable threshold ‘break’ pressure to release the damper blade 220 from the closed position is dependent on a number of parameters. These parameters may, for example: the cross-sectional area of the opening through the frame 210; the size and strength of magnet 240; the size and elasticity of resilient member 230, friction in the pivotal coupling between frame 210 and damper blade 220, etc.

As with apparatus 100, use of a ferromagnetic frame and a paramagnetic damper blade facilitates the provision of a lower or ‘soft break’ force required to release the damper blade from the closed position, as compared to, e.g., the use of a ferromagnetic frame and a ferromagnetic damper blade.

For example, testing indicated that for a steel (i.e. ferromagnetic) frame 210 with a 36.8 cm² opening, an aluminum (i.e. paramagnetic) damper blade 220, and a 105 gauss magnet 240, the damper flap remained in the closed position until a 0.09 kPa airflow pressure was applied to the upstream face of the damper flap, at which point the magnetic holding force was overcome and the damper blade moved to the open position.

As discussed above, apparatus 100 or 200 may be used to inhibit ducted supply air from entering a building or ventilation system due to naturally occurring pressure differentials. In a particular application, apparatus 100 or 200 may be used as a non-powered freeze protection system for a supply conduit (i.e. fresh air inflow) of a thermal recovery ventilation system.

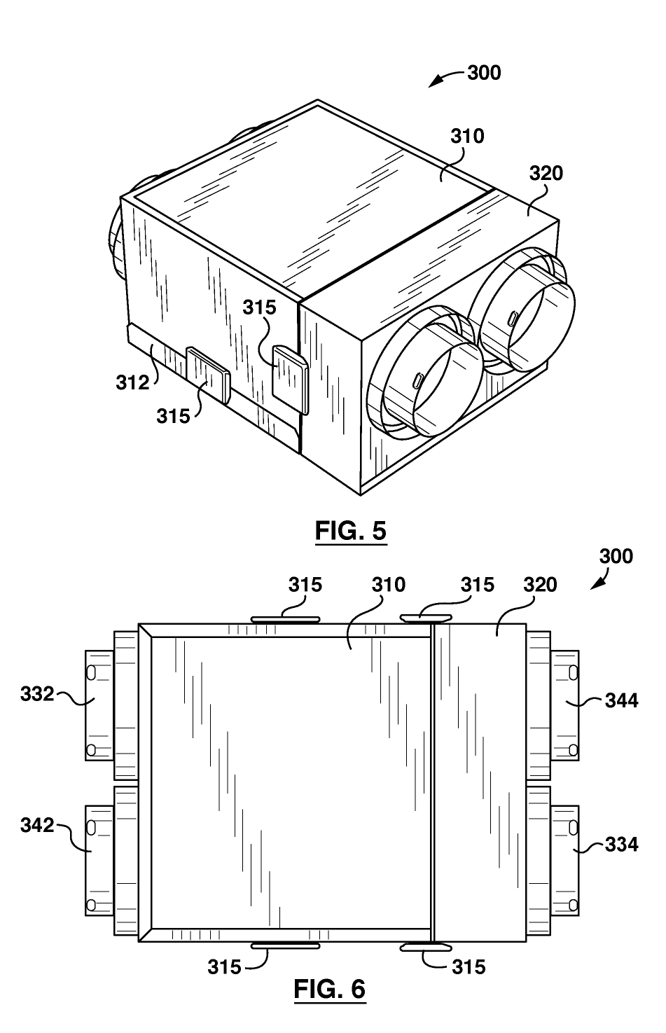

FIGS. 5, 6, and 7 illustrate a thermal recovery ventilation system or thermal recovery unit 300. Thermal recovery unit 300 may be designed for use in a residential building and/or a single residential unit within a multi-unit building. For example, thermal recovery unit 300 may be installed so that air from a bathroom, which is typically relatively warm air, may be exhausted through a heat exchanger in order to increase the temperature of outside air as it is drawn into the residential building and/or residential unit. Typically, the outside air conduit is connected to an air conditioning appliance for distribution.

In the illustrated example, thermal recovery unit 300 includes a main body 310 and a removable fan and control cassette 320 that houses fans or blowers 360 and 362 (and their controls). Removable cassette 320 is releasably secured to main body 310 using a pair of latches 315. A lower access panel 312 is also releasably secured to main body 310 using another pair of latches 315. It will be appreciated that variant designs of thermal recovery units may be used in alternative embodiments.

Thermal recovery unit 300 has a first air intake or inlet 332 for drawing in air from outside the building or unit, and a first air outlet or exhaust 334 for supplying air to a device or appliance for tempering or conditioning the air before it enters the residential unit to provide an environment with desired air characteristics. Thermal recovery unit 300 also has a second air intake or inlet 342 for drawing in air from a bathroom or other expected source or warm air, and a second air outlet or exhaust 344 for exhausting the air to the outside of the building. It will be appreciated that one or more of intakes 332, 334 and exhausts 334, 344 will typically be coupled to airflow conduits or ducting (not shown) to convey air from the intake or exhaust to a remote location in the ventilation system. For example, a conduit may be provided from exhaust 344 to a location proximate the building envelope, such as a shrouded wall exhaust and/or exhaust shaft and the like.

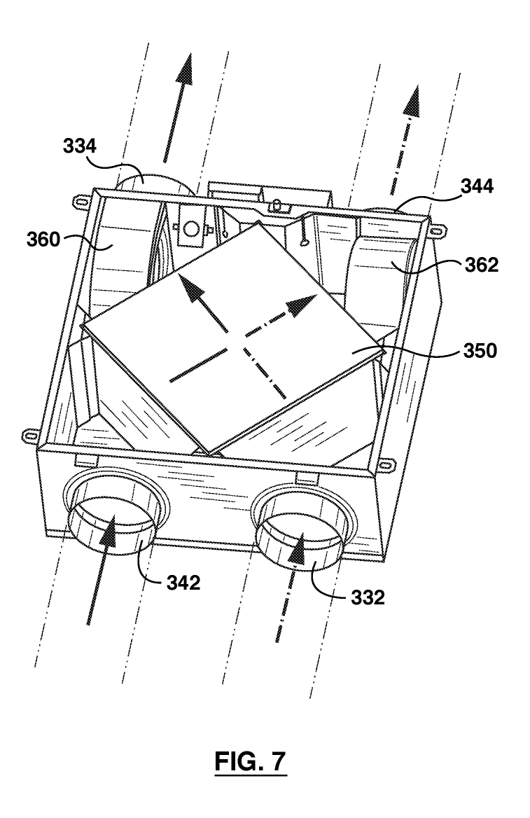

As shown in FIG. 7, thermal recovery unit 300 also includes a heat exchanger 350, such as a cross-flow or counter-flow heat exchanger. In use, supply fan 360 induces an airflow to draw air in from inlet 332, through heat exchanger 350, and out of outlet 334. Concurrently, supply fan 362 induces an airflow to draw air in from inlet 342, through heat exchanger 350, and out of outlet 344. In this arrangement, when air from air inlet 342 is warmer than air from inlet 332, air flowing from inlet 332 to 334 will be passively warmed by air flowing from inlet 342 to 344. This will often be the case when inlet 342 draws in air from a residential bathroom, and inlet 332 draws in air from the exterior or intake shaft of the residence, particularly in colder climates,

To inhibit air (e.g. very cold air) from entering the residential unit or ventilation system appliance or device (e.g. an air conditioning unit) in an uncontrolled manner, an apparatus 100 may be positioned downstream of supply fan 360. For example, apparatus 100 may be mounted to or over first air outlet or exhaust 334. As discussed above, apparatus 100 is preferably mounted 76 mm (3 inches) or less from supply fan 360.

In this location, when supply fan 360 is turned on and increases the airflow pressure upstream of the apparatus 100 above a predetermined threshold, damper blade 120 is moved to and is maintained in the open position, thereby allowing outside air to be drawn into the building via inlet 332. However, if supply fan 360 is turned off, cycled to a lower power setting, or fails, damper blade 120 is moved to and is retained in the closed position, thereby inhibiting outside air from entering the building via inlet 332. In this manner, apparatus 100 may act as a freeze protection system by inhibiting very cold air from entering the building and/or a downstream air conditioning appliance due to naturally occurring pressure differentials.

As used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. An apparatus for inhibiting airflow through a conduit, the apparatus comprising:
a frame configured for mounting in fixed relation to the conduit in a position a first distance downstream of an airflow fan, the frame having an upstream face and a downstream face, the frame defining a central aperture from the upstream face to the downstream face;
a damper blade pivotally secured to the frame and moveable between a closed position in which a perimeter of the damper blade abuts the downstream face of the frame and airflow through the aperture is inhibited and an open position in which the damper blade is spaced apart from the downstream face of the frame and airflow through the aperture is permitted;
a biasing member coupled to the frame and configured to be in contact with a downstream face of the damper blade when the damper blade is in the open position to exert a biasing force against the damper blade to urge the damper blade towards a substantially closed position, wherein the biasing member is positioned downstream of the downstream face of the frame; and
a magnet coupled to the damper blade and configured to exert a magnetic force between the frame and the magnet to pull the damper blade from the substantially closed position to the closed position;
wherein when the damper blade is in the open position and an airflow pressure provided by the airflow fan falls below a first predetermined threshold, the biasing force exerted by the biasing member moves the damper blade to the substantially closed position, and the magnetic force then pulls the damper blade to the closed position and releasably retains the damper blade in the closed position, thereby inhibiting airflow through the conduit, and
wherein when the damper blade is in the closed position and an airflow pressure provided by the airflow fan is increased to a second predetermined threshold, the magnetic force is overcome and the damper blade moves towards the open position.

2. The apparatus of claim 1, wherein the damper blade is made from a paramagnetic material and the frame is made from a ferromagnetic material.

3. The apparatus of claim 2, wherein the damper blade is made from at least one of aluminum, tin, and titanium.

4. The apparatus of claim 2, wherein the frame is made from at least one of galvanized steel and stainless steel.

5. The apparatus of claim 1, wherein the frame further comprises a flange extending outwardly from the downstream face of the frame, and wherein the biasing member comprises a resiliently flexible member having a first end and a second end, the first end being secured to the flange, and the second end configured to abut the downstream face of the damper blade when the damper blade is in the open position.

6. The apparatus of claim 5, wherein the first end of the resiliently flexible member has a width that is greater than a width of the second end of the resiliently flexible member.

7. The apparatus of claim 5, wherein the resiliently flexible member is made from at least one of stainless steel, spring steel, and rubber.

8. The apparatus of claim 1, wherein the magnet has a strength of at least 32 Gauss.

9. The apparatus of claim 8, wherein the magnet has a strength of between 32 and 105 Gauss.

10. The apparatus of claim 1, wherein the perimeter of the damper blade is generally rectangular.

11. The apparatus of claim 1, wherein the perimeter of the damper blade is generally circular.

12. The apparatus of claim 1, wherein the first predetermined threshold is about 0.085 kPa, and the second predetermined threshold is about 0.009 kPa

13. The apparatus of claim 1, wherein the conduit is a supply air inlet of a thermal recovery unit.

14. The apparatus of claim 1, wherein the first distance is less than 76 mm.

15. A thermal recovery unit for installation in a residential dwelling, the thermal recovery unit comprising:
a housing having an interior air inlet, an exterior air inlet, an interior air outlet, and an exterior air outlet;
a first conduit extending between the interior air inlet and the exterior exhaust outlet;
a second conduit extending between the exterior air inlet and the interior air outlet;
a supply fan positioned adjacent to the interior air outlet; and
a damper assembly positioned downstream of the supply fan by a first distance, the damper assembly comprising:
a frame having an upstream face and a downstream face;
a damper blade pivotally secured to the frame and moveable between a closed position in which airflow through the second conduit is inhibited and an open position in which airflow through the second conduit is permitted;
a biasing member coupled to the frame and configured to be in contact with a downstream face of the damper blade when the damper blade is in the open position to exert a biasing force against the damper blade to urge the damper blade towards a substantially closed position; and
a magnet coupled to the damper blade and configured to exert a magnetic force between the frame and the magnet to pull the damper blade from the substantially closed position to the closed position;
wherein when the damper blade is in the closed position, the supply fan is operable to provide an airflow pressure sufficient to overcome the magnetic force and move the damper blade to the open position, and
wherein when the damper blade is in the open position and the supply fan is turned off, the biasing force exerted by the biasing member moves the damper blade to the substantially closed position, and the magnetic force then pulls the damper blade to the closed position, thereby automatically closing the damper assembly.

16. The thermal recovery unit of claim 15, wherein the first distance is less than 76 mm.
